(19) United States
(12) Patent Application Publication
(10) Pub. No.: US 2007/0124330 A1
(43) Pub. Date: May 31, 2007

(54) Methods of rendering information services and related devices

(76) Inventor: Lydia Glass, Monrovia, CA (US)

Correspondence Address: Rolando J. Tong, PO Box 802691, Valencia, CA, 91380, US

(21) Appl. No.: 11/599,918

(22) Filed: Nov. 15, 2006

Related U.S. Application Data
(60) Provisional application No. 60/737,549, filed on Nov. 17, 2005.

(51) Int. Cl. G06F 17/00; G06Q 30/00

(52) U.S. Cl. 707/103 R; 705/26

(57) ABSTRACT

A business method and related apparatus comprising providing a database storing information pertaining to a plurality of objects; providing object identifiers corresponding to each of the plurality of objects; posting at least one object identifier in a visible manner to a user; allowing the user to use a communication device to transmit the object identifier through the database, the communication device being able to communicate with the database; and, providing the user information pertaining to the object that corresponds to the object identifier.

### CROSS REFERENCE TO RELATED APPLICATIONS

This application is related to and claims the benefit of priority from U.S. provisional application Ser. No. 60/737,549 filed Nov. 17, 2005 and U.S. provisional Ser. No. (TBD) filed Nov. 6, 2006, the entire contents of which are incorporated herein.

### FIELD OF INVENTION

The present invention relates to image analysis, particularly devices and business methods involving rendering of information about an object.

### BACKGROUND

Image recognition devices have been used for years in fingerprint identification. These devices are now being used in face recognition applications, such as in airports and police departments. These devices typically include a camera, a scanner, an object identifier database, and an information database to make positive identifications. Once the object is photographed, the object is scanned by the system; the object identifier maps the photo; and, the object identifier compares it to stored maps, which are in the form of fingerprints or faces stored in a database. The system retrieves matches that are substantially close to the object presented for recognition.

The applicant has discovered a novel way of extending the application of existing image recognition devices to provide information about popular, intriguing, or uncommon objects a person may encounter. The information being provided may include historical information, factual description, and scientific or statistical information. The applicant has further discovered novel devices and methods of doing business that involve rendering services in the nature of providing persons or entities with said information about said objects.

### BRIEF SUMMARY

The present invention includes a business method comprising: providing a database storing information pertaining to a plurality of objects; allowing a user to capture an image of an object using an image capturing device; allowing the user to use a communication device, the communication device being able to communicate with the database; allowing the user to transmit the captured image of the object through the database via the communication device; matching the captured image of the object with an object stored in the database; and providing the user information pertaining to the object that matches the captured image of the object.

The present invention also includes a business method comprising: providing a database storing information pertaining to a plurality of objects; providing object identifiers corresponding to each of the plurality of objects; posting at least one object identifier in a visible manner to a user; allowing the user to use a communication device to transmit the object identifier to a processor, the processor being configured to access the database; and providing the user information pertaining to the object that corresponds to the object identifier.

The present invention further includes an image recognition device comprising: an electronic storage device configured to store data, the data comprising information describing an object and an object identifier that corresponds to the object; a processor in communication with the electronic storage device, the processor being configured to selectively extract data from the electronic storage device; an image capturing device, the image capturing device being configured to provide a captured image to the processor and allow the processor to obtain from the electronic storage device information describing the object that corresponds to the object identifier.

The present invention includes an image recognition device comprising an electronic storage device configured to store data, the data comprising information describing an object and an object identifier that corresponds to the object; a processor in communication with the electronic storage device, the processor being configured to selectively extract data from the electronic storage device; and a communication device in communication with processor, the communication device being configured to provide an object identifier to the processor and allow the processor to obtain from the electronic storage device information describing the object that corresponds to the object identifier.

The above description sets forth, rather broadly, a summary of certain embodiments of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a flow chart of an embodiment of a business method of the present invention.

FIG. 2 is substantially a flow chart of an embodiment of a business method of the present invention.

FIG. 3 is substantially a schematic diagram of devices that may be used to execute the business method shown in FIG. 1.

FIG. 4 is substantially a schematic diagram of devices that may be used to execute the business method shown in FIG. 1.

FIG. 5 is substantially a schematic diagram of devices that may be used to execute the business method shown in FIG. 1.

FIG. 6 is substantially a front view of the communication device of the present invention.

### DETAILED DESCRIPTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

The order in which the steps are presented below is not limited to any particular order and does not necessarily imply that they have to be performed in the order presented. It will be understood by those of ordinary skill in the art that the order of these steps can be rearranged and performed in any suitable manner. It will further be understood by those of ordinary skill in the art that some steps may be omitted or added and still fall within the spirit of the invention.

As used herein, the term “internet” may interchangeably used with the term “network” to refer to a communication system that allows users to connect computers, terminals, or databases. The term “server” may interchangeably be used with the term” computer” to refer to an electronic device or a plurality of connected electronic devices that can store, retrieve, or process data or than can provide service for computers connected thereto.

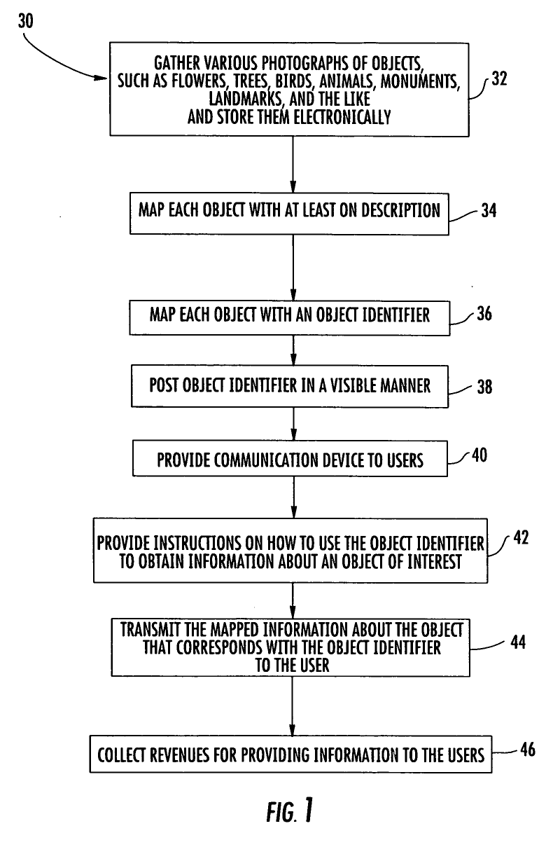

The present invention comprises information service business methods (ISBMs) and devices involved in executing said methods. Referring now to FIG. 1, a first embodiment 30 of an ISBM is shown wherein at step 32, various photographic images of objects, such as flowers, trees, birds, animals, monuments, landmarks, and the like are gathered and stored electronically. It is understood that the objects may be any object the users of the ISBM desire to include in their collection, including living or non-living objects. The photographic images may have been captured by the users, or may have been obtained from existing publications. The photographic images may be in the form of still photos or videos.

At step 34, each object is preferably mapped with at least one description, which may include known facts, statistical information, or scientific information pertaining to the object. For instance, if the object is an animal, the description may include the name of the object, Latin name or species name, descriptions including color, size, regional habitat, and interesting aspects of its history. The description may also be in the form of photographs or video clips of the object of interest.

At step 36, each object is preferably mapped with an object identifier, which may be in a numerical, alphabetical, or alpha numeric format. For instance, an object identifier “123” may be used. At step 38, the object identifier may be posted in a visible manner. For instance, in a zoo setting, the object identifier may be posted at a site where the object, such as an animal, is known to exist. In a museum setting, the object identifier may be posted right next to a painting or a work of art, such a sculpture. In a national park setting, the object identifier may be displayed using a sign or a banner, which may be positioned at a location where there is a scenic view of an attraction.

At step 40, a communication device may be provided to users, such as a telephone, a computer connected to an internet, or a wireless communication device, such as wireless telephone, personal device assistants (PDAs), or handhelds known in the art. The users may use the communication device to obtain information about a particular object by entering its corresponding object identifier. Alternatively, the users may be allowed to use their own communication devices to enter an object identifier and access information about the corresponding object.

At step 42, instructions on how to use the object identifier to obtain information about an object of interest, such as an animal, a painting, or a landmark, are preferably provided next to the sign that displays the object identifier. For instance, an instruction may say: “please lift the handset and dial 1-900-555-1212 to obtain information about the Half Dome of Yosemite National Park.” The instruction may be varied depending on the devices used to implement the ISBM of the present invention. For instance, where it is anticipated that the users will use their wireless telephone, the instruction may say: “please dial 1-900-555-1212 using your cell phone to obtain information about the Half Dome of Yosemite National Park.” In an embodiment where it is anticipated that the users will use a computer that is connected to an internet, the instruction may say: “please log on to <name of URL> and enter the object identifier to know more about <name of the object>.

At step 44, when the communication device is used and the object identifier is entered by the user, the stored information about the object that corresponds with the object identifier is preferably transmitted to the user. The stored information may be transmitted to the user through the communication device. The user may be store the information in a server or in a storage device, such as a memory card, a floppy disc, or an audio, video, or audio/video recorder.

At step 46, the operator of the ISBM preferably collects revenues for providing the mapped information to the users. Revenues may be in the form of the fee per minute the user is on the 900 number, a flat fee for subscribing to the ISBM for a particular length of time, equipment rental, software purchase and downloads, information downloads, and the like. Various creative ways to collect revenues may be implemented. The ISBM may be marketed to various publishers providing maps and site information, major encyclopedia retailers or distributors, botanical and zoological museums, and nature publications.

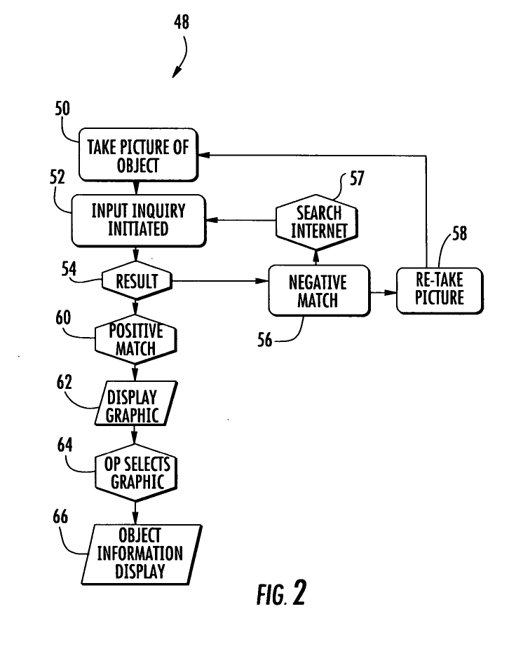

A second ISBM embodiment 48 is shown in FIG. 2 wherein users need not be provided with object identifiers. Users may simply take a picture of an object (step 50) and initiate a query with the server (step 52). The server preferably processes the query at step 54. If the server does not recognize the object (56), the server may either search the internet 57 for a similar object (57) prompt the user to retake the picture (58). The method preferably loops to step 50 or step 52 until a positive match is attained. Once the server recognizes the picture (60), the user is preferably notified using graphics or words (62). If the server finds multiple matches for the picture, the user may be provided with the matches so that the user may select from the matches (64). The server may then display the information pertaining to the object that matched the picture and that was selected by the user (66).

It can be realized that the present invention provides customers with the instant ability to obtain information about objects, such as flowers, trees, birds, animals, and monuments. It can also be realized that the present invention may be useful in settings such as museums, historical sites, and national and state parks where customers may encounter popular, intriguing, or uncommon objects and seek detailed information about said objects. It can further be realized that the present invention offers a new and exciting business opportunity from rendering services using the business methods of the present invention.

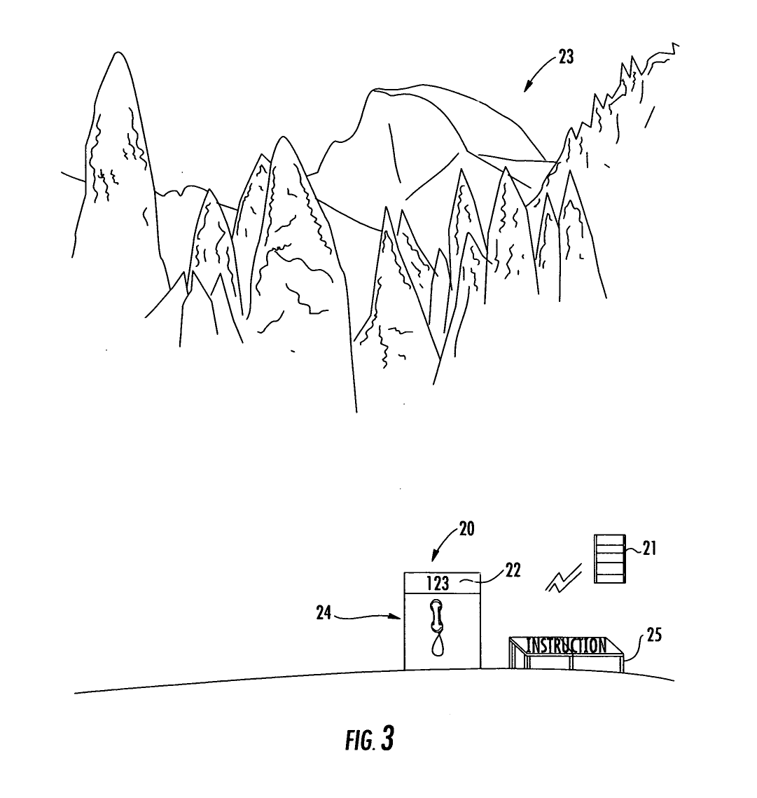

The present invention also includes information rendering apparatus to implement the ISBMs. In the first embodiment shown in FIG. 3, information rendering apparatus 20 preferably includes a communication device 24, an object identifier 22 posted in a visible manner, a posting of instructions 25 on how to use the information rendering apparatus, and a database 21. Database 21 is preferably a commercially available memory storage medium that preferably stores a plurality of data sets for a plurality of objects. The objects of interest may be monuments, landmarks, arts, and objects that exist in nature, such as trees, birds, and animals. Each data set preferably includes at least one description of the object, and an identifier corresponding to the object. The object description may be in a form of photographs, video clips, statistical information, or scientific information. The object identifier is preferably in a form of numbers, alphabets, or alpha numerals, which serves to identify an object of interest.

As shown in FIG. 3, the object of interest 23 may be a landmark, such as the Half Dome in Yosemite National Park in California. The corresponding object identifier 22 for the Half Dome may be the numbers 123. A user may read the posting of instructions 25 on how to use the information rendering apparatus 20. The user may use the communication device 24 to enter the object identifier 22 to obtain information about the object of interest 23. The communication device 24 preferably communicates with the database 21 to obtain a description of the object of interest. The description of the object of interest may include facts about the Half Dome, including elevation, average temperature, wildlife present, history, video clips, photographs during different seasons of the year, and the like.

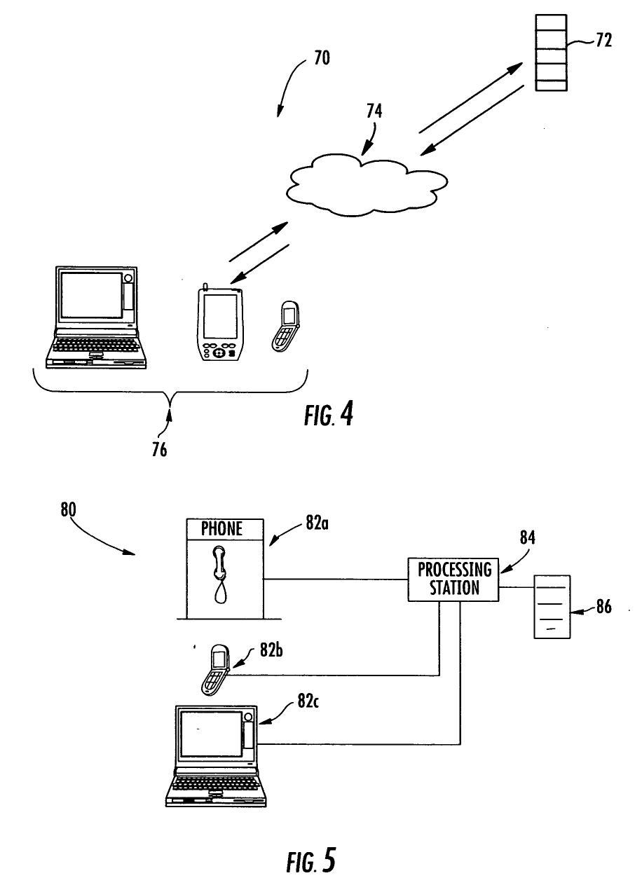

Referring now to FIG. 4, a second embodiment of the information rendering apparatus 70 preferably includes a database 72, which is preferably similar to database 21 and may be in a form of a computer, a server, or a storage device, such as a random access memory. The database 72 may be filled with data by storing photographs or electronic scans of various objects. Each object may be mapped with an object identifier and at least one description described above. The database 72 may include a processor (not shown) configured to recognize objects such as flowers, trees, birds, animals, and monuments using an image recognition software. The database 72 may be filled with image references through collaborations with major encyclopedia, botanical, zoological, museum, and nature publications.

With continued reference to FIG. 4, the database 72 is preferably connected to the internet 74 or a computer network. Information rendering apparatus 70 preferably also includes at least one type of an input device 76 configured to connect to the internet 74 or computer network and provide either a recognizable object identifier to the database 72 or an image of an object to the database 72. Input device 76 may be in a form of a computer, a wireless phone with a digital camera, or a personal digital assistant (PDA).

A user may upload an electronic image to a PDA or computer 76. The PDA or computer 76 may access the internet 74 and transmit the picture to the database 72. The processor of the database 72 may use a image recognition software to match the picture to the objects stored in the database. The processor may then extract the information of the matching object and transmit he extracted information through the internet 74 the information to the PDA or computer 76.

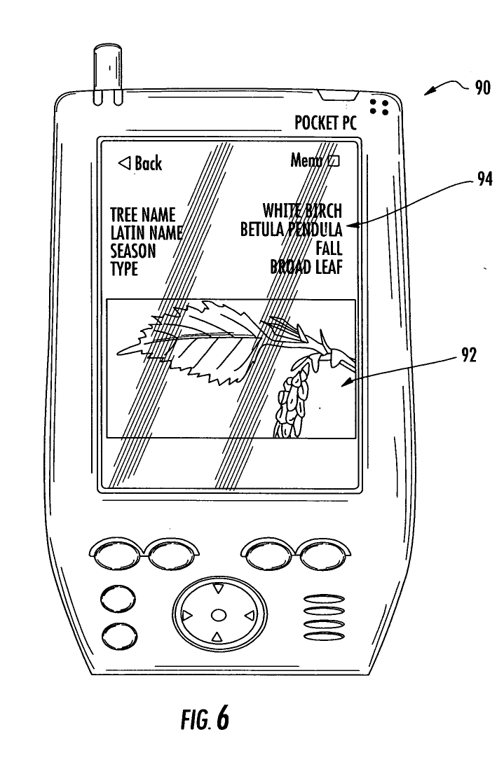

Referring now to FIG. 5, a third embodiment of the information rendering apparatus 80 preferably includes at least one communication device 82a, 82b, or 82c configured to transmit information to and from a processing station 84. Information rendering apparatus 80 preferably further includes an information database 86, which is preferably equivalent to databases 72 and 21 and is in communication with the processing station 84. Communication devices 82a, 82b, or 82c may be a land line telephone, a wireless telephone, or a computer capable of connecting to the processing station 84. Processing station 84 may include a live human operator with an access to a computer, which may serve as database 86.

Alternatively, processing station 84 may include an Interactive Voice Recognition system (IVR), which preferably uses the medium of telephonic voice recognition. The IVR system preferably prompts the user to say a predefined task, such as to identify a particular object, identify a landmark monument, or describe the object by finding the description of the object in the database. The IVR may then prompt the user to say an identifier or the object description.

For instance, the user may say “object identifier 123” or “Yosemite National Park, Calif., Half Dome.” Once the object identifier or object description is recognized from the information database 72, the IVR preferably reads back a choice of results from the query. If there are multiple choices, the user may make a selection from the voice menu. The user may then make a choice from the selection, and the IVR may read back the stored information about the object of interest to the user over the phone. If the user made an incorrect selection, the user may go back to the previous menu and make another selection. If the object is not recognized, the system preferably re-runs the recognition routine.

An IVR session may sound as follows:

IVR: Please make a selection from the following menu.

Press or say 1 to identify an object. Press or say 2 to identify a landmark or monument. Press or say 3 to describe the object using the object identifier database.

Subscriber says: 3

IVR: Please say object or landmark or monument

Subscriber says: object

IVR: Please indicate whether it is a living or inanimate object

Subscriber says: living

IVR: Please say the type of living object, for example bird, or tree

Subscriber says: bird

IVR: please indicate whether it is large or small

Subscriber says: small

IVR: please indicate the color of the bird

Subscriber says: blue

IVR: I may have identified the object you are looking for. Does this blue bird have a long or short tail?

Subscriber says: long

Does this blue bird with a long tail have field markings such as a light gray face and body with black spotted wing feathers?

Subscriber says: yes

IVR: The database has found a match. The bird you have described is a Blue Jay (Latin name Cyanocitta Cristata) which is a North American jay, a handsome bird with predominantly lavender-blue to mid-blue feathering from the top of the head to midway down the back. There is a pronounced crest on the head. The bird has an off-white underside, with a black collar around the neck and sides of the head and a white face. It occurs over a very large area of the eastern side of North America. West of the Rockies, it is replaced by the closely related Steller's Jay

IVR: Press 1 if you would you like additional information on your selection or press 2 if would you like to make a new search.

In the example shown, a blue jay was recognized from an object identifier database 86. In this case, the subscriber was walked through a series of questions in order to determine and provide a possible match for the desired object. To identify the blue jay, the following identifiers were used to provide the final results of the identifier map:

| Object Identifier | Vocal Select 1 | Vocal Select 2 | Vocal Select 3 |
|---|---|---|---|
| | Object | Landmark/monument | Object Identifier db |
| Object db | Object | Landmark | Monument |
| Object | Living | Inanimate | |
| Living | “Please say type” | Example-“bird” | Example-“tree” |
| Bird | Large | Small | |
| Small | “Please indicate | Example-“red” | Example-“blue” |
| | color” | | |
| Blue | Long tail | Short tail | |
| Long tail | Possible match | Yes-“Light gray face” | No-“Light gray face” |
| Yes | OBJECT | Blue Jay | |
| | RECOGNIZED | | |
| Blue Jay | Information | | |
| | Database | | |
| | reads/displays | | |
| | information | | |
| IVR | “Please press 1 if | “Please press 2 if you | |
| | you would like | would like to make a new | |
| | additional info” | search | |

It is noted that a plurality of communication devices may be used to transmit the extracted information. For instance, the communication device may include a telephone and a computer. Audio information may be read to the user, and catalogued images or video may be displayed on the user's computer screen, wireless telephone screen, and PDA or pocket PC screen. The information may be downloaded into the user's wireless phone, PDA, pocket PC, handheld devices, or computer. The user may be allowed to replay the information. In addition, the users may request to receive the information through their personal email accounts, or to an email subscription provided by the ISBM provider.

It is further noted that communication device 82 may be in the form of a telephone with a land line, VoIP internet phone services, as well as web enabled wireless phone or any other “pocket pc” with flash memory capabilities. Communication devices 24 may include disk storage for multimedia graphics and video. Downloads for either ecological data or travel data are preferably stored on flash card memory for web based wireless phones or other portable devices.

Information database 86 may be a part of a server computer, which may be an internet server. Subsequent information downloads by users may be made from this server and may provide information to the IVR and web queries. Information updates may be stored in this server and may be accessed by the users for the latest information. These updates can be sold as a subscription or as individual flash cards to promote sales.

The server preferably stores information used by the IVR and information database system. Data security measures are preferably implemented to protect the web site, information database, and user information. The server preferably stores user information, including profile, software purchases, and subscription information. A backup server is preferably provided in case the primary server goes down.

A web site may be established to access all applications of the service including downloads. This web site may include data access to the server, product sales, and support. It may also include other links and sites beneficial to the traveler, hiker, or naturalist. A subscriber ID and security password may be required to download or purchase software.

Referring now to FIG. 6, communication device 24 may be in a form of a pocket PC. The pocket PC preferably includes a screen 90 that displays picture of the object of interest 92 and a description of the object of interest 94. In the example shown, the object of interest may be a leaf from a tree, which is preferably displayed on screen 90. Screen 90 preferably also displays description 94 of the leaf, such as the tree from where the leaf originated, the latin name of the tree, the season when the leaf blossoms, and the type of the leaf. The pocket PC may be a commercially available personal digital assistant (PDA) having a wireless phone, camera, and a Windows Mobile software™.

It can thus now be appreciated that the present provides an instant way of recognizing and obtaining detailed information about various objects in nature, national monuments, and museums. While adventuring or traveling, a user of the device of the present invention may no longer need to bring along a load of books or guides on a trip. The present invention would enhance the travel experience and enjoyment of the user. Because of the portability of wireless phones and the increasing coverage zones, the present invention is capable of providing a wealth of information for the naturalist, hiker, or traveler.

The present invention may be used in museums and national monuments of various cities, states, countries. Short multimedia video clips providing information about popular, intriguing, or uncommon objects can be played on the spot without having to spend hours researching. While in a museum or monument, the users can simply use their wireless phones and dial the 900 number to take an audio tour via the IVR service.

Although the description above contains many specifications, these should not be construed as limiting the scope of the invention but as merely providing illustrations of some of presently preferred embodiments of this invention. For instance, various types of communication devices may be used, such as wireless phones and phones using land lines. Communication devices may be combined with the image capturing devices. Thus, the scope of the invention should be determined by the appended claims and their legal equivalents rather than by the examples given.

What is claimed is:

1. A business method comprising: providing a database storing information pertaining to a plurality of objects; allowing a user to capture an image of an object using an image capturing device; allowing the user to use a communication device, the communication device being able to communicate with the database; allowing the user to transmit a captured image of the object through the database via the communication device; matching the captured image of the object with an object stored in the database; and providing the user information pertaining to the object that matches the captured image of the object.

2. The business method of claim 1, further comprising providing the communication device.

3. The business method of claim 1, wherein the image capturing device and the communication device are integrated into a single device.

4. A business method comprising: providing a database storing information pertaining to a plurality of objects; providing object identifiers corresponding to each of the plurality of objects; posting at least one object identifier in a visible manner to a user; allowing the user to use a communication device to transmit the object identifier through the database, the communication device being able to communicate with the database; and providing the user information pertaining to the object that corresponds to the object identifier.

5. The business method of claim 4, further comprising providing instruction to the user on how to use the object identifier to obtain information.

6. The business method of claim 4, further comprising designating a 900 number for the communication device to dial to access the database.

7. A business method comprising: providing a database storing information pertaining to a plurality of objects; providing object identifiers corresponding to each of the plurality of objects; posting at least one object identifier in a visible manner to a user; allowing the user to use a communication device to transmit the object identifier to a processor, the processor being configured to access the database; and providing the user information pertaining to the object that corresponds to the object identifier.

8. The business method of claim 7, wherein the database is a computer and the processor is a human being, the human being being assigned to operate the computer to extract the information pertaining to the object that corresponds to the object identifier.

9. The business method of claim 7, wherein the processor is a computer programmed to access the database and extract the information pertaining to the object that corresponds to the object identifier.

10. An image recognition device comprising:
(A) an electronic storage device configured to store data, the data comprising information describing an object and an object identifier that corresponds to the object;
(B) a processor in communication with the electronic storage device, the processor being configured to selectively extract data from the electronic storage device; and
(C) a communication device in communication with processor, the communication device being configured to provide an object identifier to the processor and allow the processor to obtain from the electronic storage device information describing the object that corresponds to the object identifier.

11. The image recognition device of claim 10, wherein the communication device comprises a computer connected to a network.

12. The image recognition device of claim 10, wherein the communication device comprises a telephone.

13. The image recognition device of claim 10, wherein the electronic storage device comprises data pertaining to a national landmark.

14. The image recognition device of claim 10, wherein the electronic storage device comprises data pertaining to a plant, the data comprising a scientific name of the plant.

15. The image recognition device of claim 10, wherein the electronic storage device comprises data pertaining to a work of art, the data comprising an artist name.

16. The image recognition device of claim 10, wherein the communication device is configured to receive the data selectively extracted from the electronic storage device.
